(19) United States
(12) Patent Application Publication
(10) Pub. No.: US 2007/0073899 A1
(43) Pub. Date: Mar. 29, 2007

(54) Techniques to synchronize heterogeneous data sources

(76) Inventors: Francis P. Judge, Haverhill, MA (US); Michael D. Bonnette, Hollis, NH (US); Paul M. Emond, Atkinson, NH (US)

Correspondence Address: KACVINSKY, LLC;SUITE 300, 4500 BROOKTREE ROAD, WEXFORD, PA, 15090, US

(21) Appl. No.: 11/227,598

(22) Filed: Sep. 15, 2005

(51) Int. Cl. G06F 15/16

(52) U.S. Cl. 709/246

(57) ABSTRACT

A system, apparatus, method and article for techniques to synchronize heterogeneous data sources are described. The apparatus may include an application client, and multiple server access modules each corresponding to a different type of application server. Each server access module may comprise, for example, a data synchronization module to synchronize information between the application client and a corresponding application server, a protocol translation module to communicate information using an application server protocol for the corresponding application server, and a data format converter to convert information between an application client data format for the application client and an application server data format for the corresponding application server. Other embodiments are described and claimed.

### BACKGROUND

Communication and computing technologies are starting to converge into a single wireless mobile device with continuously decreasing form factors. For example, handheld “smart phones” are emerging that combine capabilities such as voice and data communications typically provided by a cellular telephone with application programs typically provided by a computer. Consequently, a mobile user may use a single device to make telephone calls, maintain calendars and contacts, browse the Internet, communicate electronic mail (“email”), and more. The increased levels of functionality, however, may provide an increased level of complexity for a user, thereby potentially limiting the usefulness of some smart phones.

### BRIEF DESCRIPTION OF THE DRAWINGS

FIG. 1 illustrates one embodiment of a system.

FIG. 2 illustrates one embodiment of a node.

FIG. 3 illustrates one embodiment of a radio sub-system.

FIG. 4 illustrates one embodiment of a processing sub-system.

FIG. 5 illustrates one embodiment of a software architecture.

FIG. 6 illustrates one embodiment of a server access module.

FIG. 7 illustrates one embodiment of a logic diagram.

### DETAILED DESCRIPTION

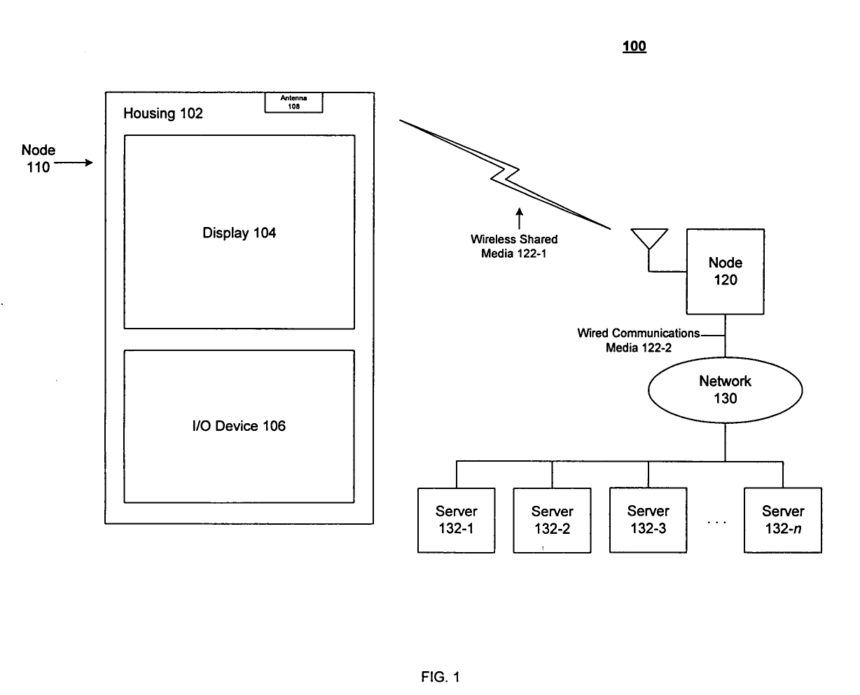

FIG. 1 illustrates one embodiment of a system. FIG. 1 illustrates a block diagram of a system 100. In one embodiment, for example, the system 100 may comprise a communication system having multiple nodes. A node may comprise any physical or logical entity for communicating information in the system 100 and may be implemented as hardware, software, or any combination thereof, as desired for a given set of design parameters or performance constraints. Although FIG. 1 is shown with a limited number of nodes in a certain topology, it may be appreciated that system 100 may include more or less nodes in any type of topology as desired for a given implementation. The embodiments are not limited in this context.

In various embodiments, a node may comprise a device, such as a processing system, computing system, mobile computing system, mobile computing device, mobile wireless device, computer, computer platform, computer system, computer sub-system, server, workstation, terminal, personal computer (PC), laptop computer, ultra-laptop computer, portable computer, handheld computer, personal digital assistant (PDA), cellular telephone, combination cellular telephone/PDA, smart phone, pager, one-way pager, two-way pager, messaging device, and so forth. The embodiments are not limited in this context.

In various embodiments, a node or a portion of a node may be implemented using hardware, software, or a combination of both. For example, the hardware may include electronic elements fabricated on a substrate. In various implementations, the electronic elements may be fabricated using silicon-based integrated circuit (IC) processes such as complementary metal oxide semiconductor (CMOS), bipolar, and bipolar CMOS (BiCMOS) processes, for example. Examples of hardware may include electrical or electronic elements, such as a microprocessor, an integrated circuit, a programmable logic device (PLD), a digital signal processor (DSP), a processor, a circuit, a logic gate, a register, a microprocessor, an integrated circuit, a semiconductor device, a chip, a transistor, and so forth. The embodiments are not limited in this context.

In various embodiments, a node or portions of a node may be implemented using software. The term “software” may refer to program instructions and/or data adapted for execution by a processor. The term “program instructions” may refer to an organized list of commands comprising words, values or symbols arranged in a predetermined syntax, that when executed, may cause a processor to perform a corresponding set of operations. Examples of a computer language may include C, C++, Java, BASIC, Perl, Matlab, Pascal, Visual BASIC, JAVA, ActiveX, assembly language, machine code, and so forth. The software may be stored using any type of computer-readable media or machine-readable media. Furthermore, the software may be stored on the media as source code or object code. The software may also be stored on the media as compressed and/or encrypted data. As used herein, the term “software” may generically encompass any type of software, such as programs, applications, computer programs, application programs, system programs, machine programs, operating system software, middleware, firmware, software modules, routines, subroutines, method, procedures, functions, software interfaces, application program interfaces (API), instruction sets, computing code, computer code, code segments, computer code segments, words, values, symbols, or any combination thereof. The embodiments are not limited in this context.

System 100 may be implemented as a wired communication system, a wireless communication system, or a combination of both. Although system 100 may be illustrated using a particular communications media by way of example, it may be appreciated that the principles and techniques discussed herein may be implemented using any type of communication media and accompanying technology. The embodiments are not limited in this context.

When implemented as a wired system, for example, system 100 may include one or more nodes arranged to communicate information over one or more wired communications media. Examples of wired communications media may include a wire, cable, printed circuit board (PCB), backplane, switch fabric, semiconductor material, twisted-pair wire, co-axial cable, fiber optics, and so forth. The communications media may be connected to a node using an input/output (I/O) adapter. The I/O adapter may be arranged to operate with any suitable technique for controlling information signals between nodes using a desired set of communications protocols, services or operating procedures. The I/O adapter may also include the appropriate physical connectors to connect the I/O adapter with a corresponding communications medium. Examples of an I/O adapter may include a network interface, a network interface card (NIC), disc controller, video controller, audio controller, and so forth. The embodiments are not limited in this context.

When implemented as a wireless system, for example, system 100 may include one or more wireless nodes arranged to communicate information over one or more types of wireless communication media, sometimes referred to herein as wireless shared media. An example of a wireless communication media may include portions of a wireless spectrum, such as one or more frequencies or frequency bands of the radio-frequency (RF) spectrum. The wireless nodes may include components and interfaces suitable for communicating information signals over the designated wireless spectrum, such as one or more antennas, radios, wireless transmitters/receivers (“transceivers”), baseband processors, amplifiers, filters, control logic, and so forth. As used herein, the term “transceiver” may be used in a very general sense to include a transmitter, a receiver, or a combination of both. The embodiments are not limited in this context.

Various embodiments may be directed to techniques to synchronize heterogeneous data sources for a mobile computing device, such as a smart phone. In one embodiment, for example, a mobile computing device may comprise a radio sub-system to provide voice and/or data communications, and a processing sub-system to connect to the radio sub-system. The processing sub-system may have a processor and memory. The memory may store software components for execution by the processor. The software components may include an application client and multiple server access modules, each corresponding to a different type of application server. Each server access module may comprise a data synchronization module to synchronize information between the application client and a corresponding application server, a protocol translation module to communicate information using an application server protocol for the corresponding application server, and a data format converter to convert information between an application client data format for the application client and an application server data format for the corresponding application server. Consequently, various embodiments may potentially improve performance of a mobile computing device. Accordingly, a user may realize enhanced products and services.

In various embodiments, system 100 may include a wireless node 110. Wireless node 110 may comprise any node arranged with wireless capabilities. Examples of wireless node 110 may include any of the previous examples for a node as previously described. The embodiments are not limited in this context.

In one embodiment, for example, wireless node 110 may be implemented as a mobile computing device having wireless capabilities. A mobile computing device may refer to any device having a processing system and a mobile power source or supply, such as one or more batteries, for example. Examples of a mobile computing device may include a laptop computer, ultra-laptop computer, portable computer, handheld computer, palmtop computer, personal digital assistant (PDA), cellular telephone, combination cellular telephone/PDA, smart phone, pager, one-way pager, two-way pager, messaging device, data communication device, and so forth. Examples of a mobile computing device may also include computers that are arranged to be worn by a person, such as a wrist computer, finger computer, ring computer, eyeglass computer, belt-clip computer, arm-band computer, shoe computers, clothing computers, and other wearable computers. In one embodiment, for example, mobile computing device 110 may be implemented as a smart phone capable of executing computer applications, as well as voice communications and/or data communications. Although some embodiments may be described with mobile computing device 110 implemented as a smart phone by way of example, it may be appreciated that other embodiments may be implemented using other wireless mobile computing devices as well. The embodiments are not limited in this context.

As shown in FIG. 1, mobile computing device 110 may comprise a housing 102, a display 104, an input/output (I/O) device 106, and an antenna 108. Display 104 may comprise any suitable display unit for displaying information appropriate for a mobile computing device. I/O device 106 may comprise any suitable I/O device for entering information into a mobile computing device. Examples for I/O device 106 may include an alphanumeric keyboard, a numeric keypad, a touch pad, input keys, buttons, switches, rocker switches, and so forth. The embodiments are not limited in this context.

In one embodiment, system 100 may include a wireless node 120. Wireless node 120 may comprise, for example, a mobile station or fixed station having wireless capabilities. Examples for wireless node 120 may include any of the examples given for mobile computing device 110, and further including a wireless access point, base station or node B, base station radio/transceiver, router, switch, hub, gateway, and so forth. In one embodiment, for example, wireless node 120 may comprise a base station for a cellular radiotelephone communications system. Although some embodiments may be described with wireless node 120 implemented as a base station by way of example, it may be appreciated that other embodiments may be implemented using other wireless devices as well. The embodiments are not limited in this context.

In one embodiment, mobile computing device 110 and wireless node 120 may comprise part of a cellular communication system. Examples of cellular communication systems may include Code Division Multiple Access (CDMA) cellular radiotelephone communication systems, Global System for Mobile Communications (GSM) cellular radiotelephone systems, North American Digital Cellular (NADC) cellular radiotelephone systems, Time Division Multiple Access (TDMA) cellular radiotelephone systems, Extended-TDMA (E-TDMA) cellular radiotelephone systems, Narrowband Advanced Mobile Phone Service (NAMPS) cellular radiotelephone systems, third generation (3G) systems such as Wide-band CDMA (WCDMA), CDMA-2000, Universal Mobile Telephone System (UMTS) cellular radiotelephone systems compliant with the Third-Generation Partnership Project (3GPP), and so forth. The embodiments are not limited in this context.

In addition to voice communication services, mobile computing device 110 and wireless node 120 may be arranged to communicate using a number of different wireless wide area network (WWAN) data communication services. Examples of cellular data communication systems offering WWAN data communication services may include GSM with General Packet Radio Service (GPRS) systems (GSM/GPRS), CDMA/1xRTT systems, Enhanced Data Rates for Global Evolution (EDGE) systems, Evolution Data Only or Evolution Data Optimized (EV-DO) systems, Evolution For Data and Voice (EV-DV) systems, High Speed Downlink Packet Access (HSDPA) systems, and so forth. The embodiments are not limited in this respect.

In one embodiment, communication system 100 may include network 130 connected to wireless node 120 by wired communications medium 122-2. Network 130 may comprise additional nodes and connections to other networks, including a voice/data network such as the Public Switched Telephone Network (PSTN), a packet network such as the Internet, a local area network (LAN), a metropolitan area network (MAN), a wide area network (WAN), an enterprise network, a private network, and so forth. In one embodiment, for example, network 130 may be arranged to communicate information in accordance with one or more Internet protocols as defined by the Internet Engineering Task Force (IETF), such as the Transmission Control Protocol/Internet Protocol (TCP/IP), for example. Network 130 may also include other cellular radio telephone system infrastructure and equipment, such as base stations, mobile subscriber centers, central offices, and so forth. The embodiments are not limited in this context.

In various embodiments, network 130 may be connected to one or more servers 132-1-n. Servers 132-1-n may comprise any type processing system, such as a computer, server, web server, workstation or other processing device. The processing system may comprise, for example, a processor and memory. In some embodiments, servers 132-1-n may execute one or more application server programs. For example, server 132-1-n may each have the appropriate hardware and software to operate as an application server. Examples of an application server may include a server arranged to execute any type of application server programs, including groupware software or collaborative software (collectively referred to as “groupware”). Groupware may refer to a type of application software that integrates work on a single project by several concurrent users at separated nodes (e.g., workstations). Groupware may be divided into three categories depending on the level of collaboration. A first groupware category may include electronic communication tools, such as email software, faxing software, voice mail software, web publishing software, and so forth. A second groupware category may include conferencing tools, such as data conferencing software, video conferencing software, voice conferencing software, Internet forum software, chat room software, electronic meeting system software, and so forth. A third groupware category may include collaborative management tools, such as electronic calendar software, project management system software, workflow system software, knowledge management system software, social software, and so forth. The embodiments are not limited in this context.

In one embodiment, for example, application servers 132-1-n may be implemented as mail servers capable of storing and communicating messages with an application client present on certain nodes in system 100, such as mobile computing device 110. The messages may be in a text format or a multimedia format. An example of a multimedia format may include a Multipurpose Internet Application Extensions (MIME) format. Communications between servers 132-1-n and mobile computing device 110 may be accomplished via wireless node 120 and network 130, for example. Servers 132-1-n may also be capable of communicating messages to an application client present on other wired and wireless nodes accessible by servers 132-1-n via network 130 or other networks. It may be appreciated that although application servers 132-1-n may be described in the context of mail applications by way of example, it may be appreciated that application servers 132-1-n may use other application software as desired for a given implementation. The embodiments are not limited in this context.

In various embodiments, application servers 132-1-n may be arranged to communicate information in accordance with a number of different application server protocols. In one embodiment, for example, application servers 132-1-n may be implemented as email servers. For example, server 132-1 may comprise a Post Office Protocol (POP) mail application server, such as a POP3 mail server. In another example, server 132-2 may comprise an Internet Message Access Protocol (IMAP) mail application server, such as an IMAP4 mail application server. In yet another example, server 132-3 may comprise a Microsoft Exchange ActiveSync® (EAS) mail application server. In still another example, server 132-2-4 may comprise a WebDAV mail application server. In addition, one or more servers 132-1-n may also be arranged to send messages over network 130 using one protocol, such as a Simple Application Transfer Protocol (SMTP) or Extended SMTP (ESMTP), and receive messages using another protocol, such as POP3 or IMAP4. The embodiments are not limited in this context.

In various embodiments, mobile computing device 110 and wireless node 120 may also be capable of voice and/or data communications. Communications between mobile computing device 110 and wireless node 120 may be performed over wireless shared media 122-1 in accordance with a number of wireless protocols. Examples of wireless protocols may include various wireless local area network (WLAN) protocols, including the Institute of Electrical and Electronics Engineers (IEEE) 802.xx series of protocols, such as IEEE 802.11a/b/g/n, IEEE 802.16, IEEE 802.20, and so forth. Other examples of wireless protocols may include various WWAN protocols, such as GSM cellular radiotelephone system protocols with GPRS, CDMA cellular radiotelephone communication systems with 1xRTT, EDGE systems, EV-DO systems, EV-DV systems, HSDPA systems, and so forth. Further examples of wireless protocols may include wireless personal area network (PAN) protocols, such as an Infrared protocol, a protocol from the Bluetooth Special Interest Group (SIG) series of protocols, including Bluetooth Specification versions v1.0, v1.1, v1.2, v2.0, v2.0 with Enhanced Data Rate (EDR), as well as one or more Bluetooth Profiles, and so forth. Yet another example of wireless protocols may include near-field communication techniques and protocols, such as electromagnetic induction (EMI) techniques. An example of EMI techniques may include passive or active radio-frequency identification (RFID) protocols and devices. Other suitable protocols may include Ultra Wide Band (UWB), Digital Office (DO), Digital Home, Trusted Platform Module (TPM), ZigBee, and other protocols. The embodiments are not limited in this context.

In various embodiments, mobile computing device 110 may have one or more application client programs arranged to share information with one or more application servers 132-1-n. As a result, there may be a need to synchronize information between two or more devices. Conventional techniques for synchronizing information between different devices, however, may be unsatisfactory for a number of reasons. For example, an application client may need to communicate with multiple application servers, with each application server using a different type of application server protocol. Each application server protocol may have its own set of rules to define how information is communicated between programs or devices. For example, in the case of mail applications servers, each mail application server may use a different mail protocol, such as POP, IMAP, EAS, WebDAV, and so forth. Therefore, it may be difficult for a mail client to synchronize information with the different mail servers, since the mail client may need to have knowledge of the various types of different mail server protocols. This may lead to a mail client of substantial complexity and size, which may be unsuitable for a mobile computing device having limited device resources, such as processor speed, memory capacity, batter life, and so forth. Furthermore, adding new mail servers and/or mail server protocols to a device may require a substantial software and/or hardware upgrade to the device.

Various embodiments may address these and other problems. In one embodiment, for example, mobile computing device 110 may implement a software architecture for synchronizing information between heterogeneous devices. The software architecture may allow mobile computing device 110 to generically integrate data between an application client for mobile computing device 110 and multiple application servers 132-1-n. The software architecture includes component implementations, and specifies standard programmatic interfaces (API) which aid in the common requirements of synchronizing data wirelessly between an application client and multiple data source servers. As a result, the software architecture may provide a standard way in which an application client interacts with disparate data providers. This may facilitate maintenance and upgrades to mobile computing device 110, in particular allowing the application client to communicate with new types of application servers 132-1-n, as well as allowing the application client to customize a user experience based on the capabilities of a given data source. This may also provide a consistent user experience across different types of application servers, regardless of how data is synchronized to the application client. Furthermore, the modular software architecture may facilitate synchronizing data between mobile computing device 110 and multiple application servers 132-1-n in a more efficient manner.

In one embodiment, for example, the software architecture may be implemented using object-oriented programming (OOP) techniques. OOP is a computer programming paradigm. OOP assumes that a computer program is composed of a collection of individual units, or objects, as opposed to a traditional assumption that a program is a list of instructions to the computer. Each object is capable of receiving messages, processing data, and sending messages to other objects. Almost any concept may be represented as an object. Examples of an object may include menu objects, image objects, frame objects, title objects, border objects, tab objects, list objects, color blue objects, button objects, scroll bar objects, text field objects, text and image objects, and so forth. Although the software architecture may be described in the context of OOP by way of example, it may be appreciated that other software paradigms may be used as desired for a given implementation. For example, the software architecture may be implemented using a model-view-controller (MVC) architecture as well. The embodiments are not limited in this context.

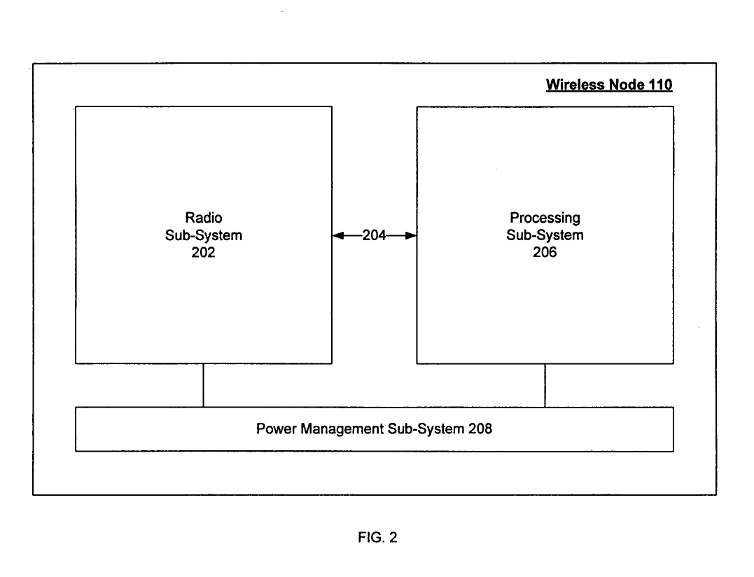

FIG. 2 illustrates one embodiment a node. FIG. 2 illustrates a more detailed block diagram of mobile computing device 10 as described with reference to FIG. 1. As shown in FIG. 2, mobile computing device 110 may comprise multiple elements. Although FIG. 2 shows a limited number of elements in a certain topology by way of example, it can be appreciated that more or less elements in any suitable topology may be used in mobile computing device 110 as desired for a given implementation. Furthermore, any element as described herein may be implemented using hardware, software, or a combination of both, as previously described with reference to node implementations. The embodiments are not limited in this context.

In various embodiments, mobile computing device 110 may include a radio sub-system 202 connected via bus 204 to a processing sub-system 206. Radio sub-system 202 may perform voice and data communications operations using wireless shared media 122-1 for mobile computing device 110. Processing sub-system 206 may execute software for mobile computing device 110. Bus 204 may comprise a USB or micro-USB bus and appropriate interfaces, as well as others.

In various embodiments, mobile computing device 110 may also include a power management sub-system 208. Power management sub-system 208 may manage power for mobile computing device 110, including radio sub-system 202, processing sub-system 206, and other elements of mobile computing device 110. For example, power management sub-system 208 may include one or more batteries to provide direct current (DC) power, and one or more alternating current (AC) interfaces to draw power from a standard AC main power supply. The embodiments are not limited in this context.

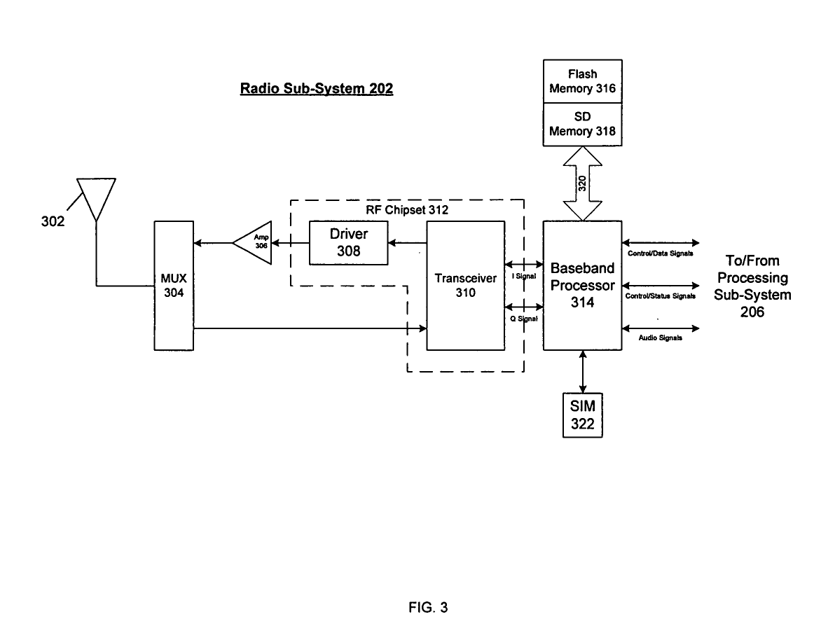

FIG. 3 illustrates one embodiment a radio sub-system. FIG. 3 illustrates a more detailed block diagram of radio sub-system 202 as described with reference to FIG. 2. Radio sub-system 202 may perform voice and data communication operations for mobile computing device 110. For example, radio sub-system 202 may be arranged to communicate voice information and control information over one or more assigned frequency bands of wireless shared media 122-1. The embodiments are not meant to be limited, however, to the example given in FIG. 3.

In various embodiments, radio sub-system 202 may include an antenna 302. Antenna 302 may broadcast and receive RF energy over wireless shared media 122-1. Examples for antenna 302 may include an internal antenna, an omni-directional antenna, a monopole antenna, a dipole antenna, an end fed antenna, a circularly polarized antenna, a micro-strip antenna, a diversity antenna, a dual antenna, an antenna array, a helical antenna, and so forth. The embodiments are not limited in this context.

In various embodiments, antenna 302 may be connected to a multiplexer 304. Multiplexer 304 multiplexes signals from amplifier 306 for delivery to antenna 302. Multiplexer 304 demultiplexes signals received from antenna 302 for delivery to RF chipset 312. The embodiments are not limited in this context.

In various embodiments, multiplexer 304 may be connected to a power amplifier 306. Power amplifier 304 may be used to amplify any signals to be transmitted over wireless shared media 122-1. Power amplifier 304 may work in all assigned frequency bands, such as 4 frequency bands in a quad-band system. Power amplifier 304 may also operate in various modulation modes, such as Gaussian Minimum Shift Keying (GSMK) modulation suitable for GSM systems and 8-ary Phase Shift Keying (8-PSK) modulation suitable for EDGE systems. The embodiments are not limited in this context.

In various embodiments, power amplifier 306 may be connected to an RF chipset 312. RF chipset 312 may also be connected to multiplexer 304. In one embodiment, RF chipset 312 may comprise an RF driver 306 and an RF transceiver 308. RF chipset 312 performs all of the modulation and direct conversion operations required for GMSK and 8-PSK signal types for quad-band E-GPRS radio. RF chipset 312 receives analog I & Q signals from a baseband processor 314, and converts them to an RF signal suitable for amplification by amplifier 306. Similarly, RF chipset 312 converts the signals received from wireless shared media 122-1 via antenna 302 and multiplexer 304 to analog I & Q signals to be sent to baseband processor 314. Although RF chipset 312 uses two chips by way of example, it may be appreciated that RF chipset 312 may be implemented using more or less chips and still fall within the intended scope of the embodiments. The embodiments are not limited in this context.

In various embodiments, RF chipset 312 may be connected to baseband processor 314. Baseband processor 314 may perform baseband operations for radio sub-system 202. Baseband processor 314 may comprise both analog and digital baseband sections. The analog baseband section includes I & Q filters, analog-to-digital converters, digital-to-analog converters, audio circuits, and other circuits. The digital baseband section may include one or more encoders, decoders, equalizers/demodulators, GMSK modulators, GPRS ciphers, transceiver controls, automatic frequency control (AFC), automatic gain control (AGC), power amplifier (PA) ramp control, and other circuits. The embodiments are not limited in this context.

In various embodiments, baseband processor 314 may also be connected to one or more memory units via a memory bus 320. In one embodiment, for example, baseband processor 314 may be connected to a flash memory unit 316 and a secure digital (SD) memory unit 318. Memory units 316, 318 may be removable or non-removable memory. In one embodiment, for example, baseband processor 314 may use approximately 1.6 megabytes of static read-only memory (SRAM) for E-GPRS and other protocol stack needs.

In various embodiments, baseband processor 314 may also be connected to a subscriber identity module (SIM) 322. Baseband processor 314 may have a SIM interface for SIM 322. SIM 322 may comprise a smart card that encrypts voice and data transmissions and stores data about the specific user so that the user can be identified and authenticated to the network supplying voice or data communications. SIM 322 may also store data such as personal phone settings specific to the user and phone numbers. SIM 322 can be removable or non-removable. The embodiments are not limited in this context.

In various embodiments, baseband processor 314 may further include various interfaces for communicating with a host processor of processing sub-system 206. For example, baseband processor 314 may have one or more universal asynchronous receiver-transmitter (UART) interfaces, one or more control/status lines to the host processor, one or more control/data lines to the host processor, and one or more audio lines to communicate audio signals to an audio sub-system of processing sub-system 206. The embodiments are not limited in this context.

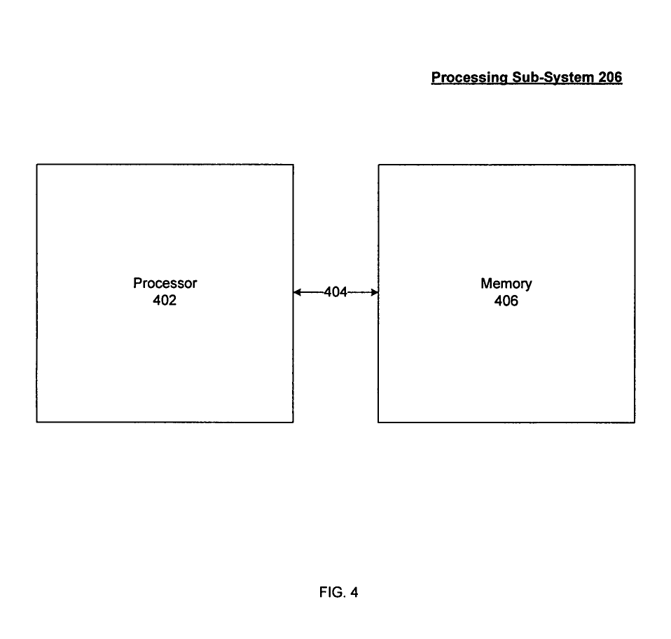

FIG. 4 illustrates one embodiment a processing sub-system. FIG. 4 illustrates a more detailed block diagram of processing sub-system 206 as described with reference to FIG. 2. Processing sub-system 206 may provide computing or processing operations for mobile computing device 110. For example, processing sub-system 206 may be arranged to execute various software programs for mobile computing device 110. Although processing sub-system 206 may be used to implement operations for the various embodiments as software executed by a processor, it may be appreciated that the operations performed by processing sub-system 206 may also be implemented using hardware circuits or structures, or a combination of hardware and software, as desired for a particular implementation. The embodiments are not limited in this context.

In various embodiments, processing sub-system 206 may include processor 402. Processor 402 may be implemented using any processor or logic device, such as a complex instruction set computer (CISC) microprocessor, a reduced instruction set computing (RISC) microprocessor, a very long instruction word (VLIW) microprocessor, a processor implementing a combination of instruction sets, or other processor device. In one embodiment, for example, processor 402 may be implemented as a general purpose processor, such as a processor made by Intel® Corporation, Santa Clara, Calif. Processor 402 may also be implemented as a dedicated processor, such as a controller, microcontroller, embedded processor, a digital signal processor (DSP), a network processor, a media processor, an input/output (I/O) processor, a media access control (MAC) processor, a radio baseband processor, a field programmable gate array (FPGA), a programmable logic device (PLD), and so forth. The embodiments, however, are not limited in this context.

In one embodiment, processing sub-system 206 may include memory 406 to connect to processor 402. Memory 406 may be implemented using any machine-readable or computer-readable media capable of storing data, including both volatile and non-volatile memory. For example, memory 406 may include read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, or any other type of media suitable for storing information. It is worthy to note that some portion or all of memory 406 may be included on the same integrated circuit as processor 402 thereby obviating the need for bus 404. Alternatively some portion or all of memory 406 may be disposed on an integrated circuit or other medium, for example a hard disk drive, that is external to the integrated circuit of processor 402, and processor 402 may access memory 406 via memory bus 404. The embodiments are not limited in this context.

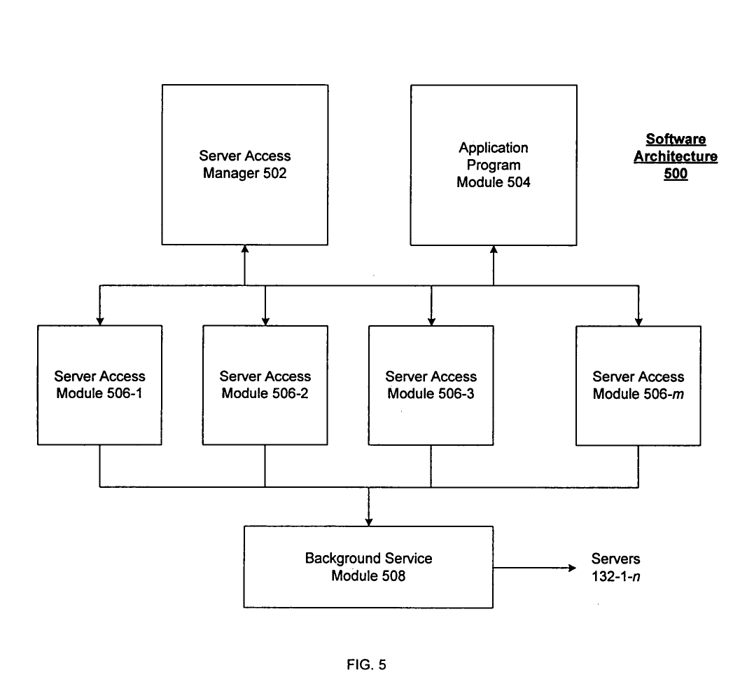

In various embodiments, memory 406 may store one or more software components. A software component may refer to one or more programs, or a portion of a program, used to implement a discrete set of operations. A collection of software components for a given device may be collectively referred to as a software architecture or application framework. An example of a software architecture for mobile computing device 110 may be described in more detail with reference to FIG. 5.

FIG. 5 illustrates one embodiment of a software architecture. FIG. 5 illustrates a software architecture 500 suitable for use with mobile computing device 110. As shown in FIG. 5, software architecture 500 may include multiple software components, such as a server access manager (SAMR) 502, an application program module (APM) 504, multiple server access modules (SAM) 506-1-m, and a background service module (BSM) 508. The software components shown in FIG. 5 are representative of some of the software components comprising software architecture 500. In some embodiments, some software components may be omitted and others added. Further, operations for some programs may be separated into more software components, or consolidated into fewer software components, as desired for a given implementation. The embodiments are not limited in this context.

In various embodiments, software architecture 500 may include APM 504. In one embodiment, for example, APM 504 may comprise an application program, such as a groupware program. More particularly, APM 504 may comprise an application client for mobile computing device 110, such as a mail client. As a mail client, application client 504 may be arranged to create, send, receive, modify, display and manage email or application messages. Application client 504 may communicate messages with other nodes of system 100 via one or more application servers 132-1-n, such as POP mail application server 132-1, IMAP mail application server 132-2, EAS mail application server 132-3, WebDAV mail application server 132-4, and so forth. Application client 504 and/or an operating system (OS) for mobile computing device 110 may have a user interface to display information to a user and receive information from a user.

In various embodiments, software architecture 500 may include one or more SAM 506-1-m. SAM 506-1-m allow application client 504 to communicate with different types of application servers 132-1-n. For example, software architecture 500 may have a SAM 506-1-m for every type of application server 132-1-n in communication with application client 504. Using the mail example, software architecture 500 may include a POP SAM 506-1, an IMAP SAM 506-2, an EAS SAM 506-3, a WebDAV SAM 506-4, and so forth. Application client 504 may then use an appropriate SAM 506-1-m to communicate with a desired type of application server 132-1-n. By abstracting application client 504 from the implementation details associated with a particular application server, application client 504 may be considerably more lightweight and consume fewer resources than conventional application programs. The embodiments are not limited in this context.

In various embodiments, a new SAM 506-1-m may be created or defined when integrating a new application server 132-1-n for use with mobile computing device 110. SAM 506-1-m may represent a given application server 132-1-n to application client 504 using a set of predefined interfaces. SAM 506-1-m may communicate to a corresponding application server 132-1-n over a wireless connection, such as shared wireless media 122-1, or a wired communication medium via synchronization operations with another device, such as a desktop computer (e.g., a “hotsync”). In both cases, SAM 506-1-m may communicate with application server 132-1-n using the same device code.

In various embodiments, SAM 506-1-m may operate using both PUSH and/or PULL techniques. In one embodiment, for example, SAM 506-1-m may provide network client side socket based communication to application servers 132-1-n, although other techniques may be used as well. As server data is received by mobile computing device 110, a SAM 506-1-m may synchronize the data to a targeted application on mobile computing device 110, such as application client 504. This may be accomplished using a standard set of interfaces referred to herein as “IData” interfaces. The IData interfaces may comprise a collection of programmatic interfaces (API) that provide data access to application data models. For example, the IData interfaces may allow a SAM 506-1-m to store email messages, calendar information, or contact data on mobile computing device 110. When synchronizing data from mobile computing device 110 up to the server, SAM 506-1-m may intelligently determine changes in application client 504 by querying for changes using the same IData interfaces, and then sending the changes to application servers 132-1-n.

In various embodiments, SAM 506-1-m may perform three main sets of operations. The first set of operations relate to communicating with a given application server using a specific protocol for the application server, such as encoding requests to send to the application server and decoding responses from the application server. The second set of operations relate to synchronizing data between the application client and a given application server, such as determining what changes to store on the application client from the application server, and what changes in the application client to send to the application server. The third set of operations relate to translating between a data model used by the application client for a given object (e.g., email message, calendar event, contact information) and a data model used by the application server for a given object. For example, application client 504 may use an IData data model and associated set of IData interfaces, as described in more detail below. SAM 506-1-m may provide component implementations that aid in all three of these responsibilities, and others as well.

In various embodiments, software architecture 500 may include SAMR 502. SAMR 502 may manage or coordinate operations for SAM 506-1-m. When created, or during a reset or hotsync event, a SAM 506-1-m may register itself SAMR 502 using a SAMR IRegister interface. SAMR 502 may operate as a name service for SAM 506-1-m on mobile computing device 110, as well as a central repository for functionality required by all SAM 506-1-m. The registering operations allow applications such as application client 504 to know about SAM 506-1-m, and allow applications to query one location for all SAM 506-1-m on mobile computing device 110. For example, when a user chooses to configure an application account with application client 504, application client 504 may query SAMR 502 for a list of SAM 506-1-m on mobile computing device 110, and presents the list to the user for the user to configure. Once a SAM 506-1-m is associated with a given application account, the SAM 506-1-m can expose to application client 504 and other applications the set of capabilities supported by the SAM 506-1-m through an ICapabilities interface for the SAM 506-1-m. By querying the ICapabilities interface, application client 504 at execution or runtime can customize its user experience around the functionality supported by the SAM 506-1-m. Application client 504 may specify a set of capabilities it supports which a SAM 506-1-m can choose to support or not support based upon the capabilities of a given application server 132-1-n. In addition, a SAM 506-1-m can choose to only support a subset of applications to perform synchronization operations.

In various embodiments, software architecture 500 may include BSM 508. BSM 508 may provide background support services for SAM 506-1-m. For example, BSM 508 may provide various networking capabilities to SAM 506-1-m, such as forming a foreground or background socket connection to application server 132-1-n when one or more SAM 506-1-m are performing synchronization operations. BSM 508 may also support concurrent access to data by multiple SAM 506-1-m.

In one embodiment, for example, BSM 508 may execute a state machine for a SAM 506-1-m in a manner allowing concurrent access to data for application client 504, and provides networking support (e.g., foreground and background) for any SAM 506-1-m in need of its services. When an IAction interface operation is called, SAM 506-1-m may initialize and call BSM 508 services using an API called BGServiceConverse( ). The API may take several parameters, including server connection information (e.g., server name/IP, port, use SSL or not, and so forth), and a function pointer to the first state in the state machine for SAM 506-1-m. Each state in the state machine has an operation prototype similar to the following:

UInt32 state ( ..., BGResult *presult, BGConvResponse *pprevResponse,
UInt32 *popaque, MemHandle *pnextRequestH, BGFP *pnextState ).

Each state operation receives a BGResult value which contains success/failure information of any network activity performed by BSM 508 during a previous SAM state. If a response from an application server 132-1-n was previously requested, the server data is returned in pprevResponse. The popaque parameter allows SAM 506-1-m to maintain synchronization information across states. The pnextRequestH return value allows SAM 506-1-m to return to BSM 508 a formatted request buffer to send to application server 132-1-n. Lastly the pnextState out parameter contains the next state to be called in the SAM state machine.

Using this model, application server protocol functionality comes down to sending a series of commands by having different states return values for pnextRequestH. Application server responses are interrogated by examining pprevResponse arguments passed to states. BSM 508 handles all of the creation of connections, sockets, and network library calls. As an example, the below pseudo-code implements a login operations to an IMAP application server 132-2.

```
UInt32 login( ... BGResult *presult, BGConvResponse *pprevResponse,
        MemHandle *pnextRequestH, BGFP *pnextState )
{
    ...
    If( presult->majorResult == IBG_SUCCESS )
    {
            char *ptmp, *pcmd = “1 LOGIN JOE PASSWORD\r\n”;
        *pnextRequestH = MemHandleNew( StrLen( pcmd ) +1 );
        ptmp = MemHandleLock( *pnextRequestH );
        StrCopy( ptmp, pcmd );
        MemHandleUnlock(*pnextRequestH );
          *pnextState = loginCheck;
    } else
      *pnextState = IMAPLastState; // err occurred connecting to server
    return errNone;
}
UInt32 loginCheck(UInt8 currState, BGResult *presult,
      char *pprevResponse, MemHandle *pnextRequestH, UInt8
      *pnextState )
{
    if( presult->majorResult == IBG_SUCCESS )  // check result
    of sending rqst
    {
        if( StrStr( pprevResponse, “1 OK” ) )
            *pnextState = IMAPNextState; // do next IMAP state
        else
            *pnextState = IMAPLastState; // error occurred, end state
    }
    return errNone;
}
```

In addition to the various software components discussed above, software architecture 500 may also include a set of programmatic interfaces (API) for use by the programs. An interface may comprise a category of software components that allow two or more software components to interact, communicate, or share data. Software architecture 500 may include multiple interfaces to ensure different software components can interact in a standard, well-defined manner. In one embodiment, for example, software architecture 500 may include an IConfigure interface, an ICapabilities interface, an IAction interface, and an IData interface. The embodiments, however, are not limited to these interfaces.

In various embodiments, software architecture 500 may include an IConfigure interface. The IConfigure interface may define a set of operations performed in reaction to configuration changes. More particularly, the IConfigure interface allows a SAM 506-1-m to react to configuration changes. A subroutine SCfgAccountReset( ) may be defined as follows:

Interface IConfigure
{
Err SCfgAccountReset( UInt16 refNum, MDataPersistentAccountID
acctPID );
}

The subroutine SCfgAccountReset( ) may be called when an account associated with a given SAM 506-1-m is being deleted, or has significantly changed its configuration values.

The SAM 506-1-m reacts to this subroutine by resetting any saved state it may have from previous synchronizations with a corresponding application server 132-1-n. The SAM 506-1-m should also cause any IData interfaces used by the SAM 506-1-m to reset. The subroutines to carry out the reset operations may be provided by the IData interface. For each SAM 506-1-m to be configured, this may be accomplished either via a custom user interface (UI) or through non-UI name-value pairs. In some cases a SAM 506-1-m may require a specific configuration not covered by an application wizard or server setup screens. During configuration operations of an account type for a SAM 506-1-m, application client 504 may call the SCfgDisplay( ) subroutine of this interface to allow the SAM 506-1-m to collect enough configuration information to perform actions at a later time. If a SAM 506-1-m returns from this routine the SAM_METHOD_NOTIMPL return code, application client 504 displays its own configuration user interface. In this case, the SAM 506-1-m can then use the IAccount interface to query for configuration values required to perform actions.

In addition to allowing a user interface to be displayed, a SAM 506-1-m may implement operations to query and set the values displayed in the user interface. This may allow for non-UI configuration operations to occur, and allow flexibility in the SAM 506-1-m configuration process. The above SCfgGetNVP( ) and SCfgSetNVP( ) subroutines present a name value pair paradigm for allowing this non-UI configuration to occur. It is worthy to note that in the SCfgGetNVP( ) case, the value returned is a copy of the original, and should be freed by the caller.

When calling the IConfigure subroutines, the caller passes its creator to identify the caller. In this way, the SAM 506-1-m knows which application is calling it (e.g., email, address book, date book, contacts, and forth), and may therefore customize the configurations screens as appropriate. The caller also passes a SCfgDataType parameter which is optional data the SAM 506-1-m may use during configuration operations. This data may change based on the caller, and in the case of application client 504 represents an application client account handle.

In various embodiments, software architecture 500 may include an ICapabilities interface. The ICapabilities interface is a read-only interface allowing applications to determine the capabilities of the SAM 506-1-m. Two accessor subroutines are provided, as follows:

```
typedef enum
{
      SCapGet = 1,
      SCapSend,
      SCapFullSynch,
      SCapDelete,
      SCapMove,
      SCapRead,
      SCapUnread,
      SCapConfigUI,
      ...
} SCapabilitiesType;
Interface ICapabilities
{
      Err SCapSupports( SAMRef ref, UInt32 applCreator, SCapabilities
      Type capability );
      Err SCapSupportsAppl( SAMRef ref, UInt32 applCreator );
}
```

The first accessor subroutine is a SCapSupports( ) subroutine to query functional capabilities of the SAM 506-1-m. The second accessor subroutine is a SCapSupportsAppl( ) subroutine to query if the SAM supports a particular application. The accessor subroutines return errNone if the capability is supported, otherwise the samErrUnsupported error is returned.

In various embodiments, software architecture 500 may include an IAction interface. The IAction interface provides a way in which application client 504 can cause the SAM 506-1-m to perform some action. For example, the action could be to retrieve all new items from the application server 132-1-n, perform a full synchronization with the application server 132-1-n, or send items from application client 504 to the application server 132-1-n. With each request, the caller identifies itself to the SAM 506-1-m by passing its creator. In this way the SAM 506-1-m knows what type of data interaction is to be performed with the application server 132-1-n. An example of some IAction interface subroutines include the following:

```
Interface IAction
{
      Err SActGet( UInt16 ref, UInt32 callerCreator,
      SCfgDataType *pcallerData, SActFlags flags );
      Err SActSend( UInt16 ref, UInt32 callerCreator,
      SCfgDataType *pcallerData, SActFlags flags );
      Err SActFullSync( UInt16 ref, UInt32 callerCreator,
            SCfgDataType *pcallerData, SActFlags flags );
      Err SActGroupwareFullSync( UInt16 ref, ScfgDataType
      *pcallerData, SCfgDataType *pcallerData, SActFlags flags );
}
```

The SActGroupwareFullSync( ) subroutine causes the SAM 506-1-m to fully synchronize all applications supported by the SAM 506-1-m, including application client 504. The caller also passes a SCfgDataType parameter to pass any optional data needed to carry out the request. In this parameter the application client account handle is passed to allow the SAM 506-1-m access to account information.

The SActGet( ) subroutine retrieves information from application server 132-1-n. Using the account handle and the IAccount interface, the SAM 506-1-m customizes the Get functionality for the email case by retrieving configuration settings for application client 504. Examples of configuration settings for application client 504 may include UnreadOnly, Max Message Size, and so forth.

The SActSend( ) subroutine causes the SAM 506-1-m to send data from application client 504 to the application server 506-1-m. This could be outbound email, new date book, or new address entries, depending on the calling application.

The SActFullSync( ) subroutine performs a full synchronization with the application server 132-1-n. For email, this would be performing all queued disconnected actions, then a Get, and then a Send. For date book and other personal information manager (PIM) applications, this would insure all modifications, whether device or server originated, are reflected on both sides, and all entries currently on the application server 132-1-n are on mobile computing device 110. For all these subroutines, the caller specifies whether or not the action should be performed silently or with a user interface. If the silent parameter is false, the SAM 506-1-m displays a progress UI using the SAMR 504 IProgress interface, as described further below.

In various embodiments, application client 504 may be arranged to use an IData interface. In one embodiment, for example, the IData interface may comprise a collection of application client interfaces for application client 504. The application client interfaces may allow external programs access to the application client data store and configuration information. Data associated with an application client account, folder, message, and attachment are considered individual containers or objects. Each individual container is represented as an interface. For example, application client 504 may have a set of application client interfaces including an IAccount interface, an IFolder interface, an IMessage interface, and an IAttach interface. Each individual interface has a set of operations that allow the manipulation of objects in that container.

In addition, all of the individual IData interfaces follow a hierarchy. At the top of the hierarchy is IAccount. In application client 504, an account (IAccount) has folders (IFolder) that contain messages (IMessages) that could in turn contain attachments (IAttach). An opaque handle uniquely identifies each container, providing sufficient information to allow traversing of the hierarchy. Within the hierarchy is paradigm that applies to all the interfaces that make up the IData interfaces. Objects within a container are created, saved, and released. All this is accomplished through the interface subroutines provided.

Each saved object can be identified by its handle or persistent ID. Given an object handle the caller can retrieve the persistent ID and vice versa. The handle is used in the API for all accesses to the object. The persistent ID is an efficient identifier of an object when the object needs to be retrieved at a later time once the object has been released. The memory needed for the persistent ID is always allocated by the caller. The size of the persistent ID is the minimum needed in order for the API library to track the object and maintain peak performance for retrieval of the object.

While a user is interacting with email, for example, application client 504 queues changes made to the email that the user wishes to be made on the corresponding application server 132-1-n. For example, this can be marking a message as read or deleting a message. The changes are queued in a transaction log (TxnLog), and the SAM 506-1-m can access the changes through an iterator on the TxnLog. The iterator returns a transaction object which can then be queried for its type. The transaction types may be specified on a per application basis, where the delete concept is common across all applications. After the SAM 506-1-m causes the corresponding application server 132-1-n to successfully execute a TxnLog change the SAM 506-1-m marks the change as complete in the TxnLog by calling a subroutine MTxnMarkComplete( ). Collectively, the IData interfaces may be implemented in shared libraries for the OS of mobile computing device 110. As such, the first argument for all interface subroutines is typically the library reference number.

In various embodiments, application client 504 may have an IAccount interface. Application client 504 may be arranged to store communication settings and user configured preferences in the account container. This account information is accessed via the IAccount interface. As described earlier, access to account information is achieved by obtaining an account handle, through which subroutines in the IAccount interface may be called. When an IAction subroutine is called, an account handle is passed as an argument, thereby allowing the SAM 506-1-m access to the account information needed to perform synchronization operations.

The IAccount interface provides a set of accessors which allow getting and setting of account values by data type. For example, accessors are provided for: (1) String data (MAccGetStringData( ), MAccSetStringData( )); (2) Bool data (MAccGetBoolData( ), MAccSetBoolData( )); (3) Int16 data (MAccGetlnt16Data( ), MAlccSetlnt16Data( )); and (4) Int32 data (MAccGetlnt32Data( ), MAccSetlnt32Data( )). When a caller changes values in the account they should call MAccSave( ) to save the new values. When a caller is done using the account handle they should call MAccRelease( ) to free the memory associated with the handle.

The IAccount interface is also positioned at the top of the data model hierarchy for application client 504. The IAccount interface provides access to the next lower layer in the data model hierarchy, which is IFolders. Subroutines are provided to iterate over the list of folders in the account, and to access common folders by ID, such as Inbox, Trash, Sent, Personal, and so forth.

In various embodiments, application client 504 may have an IMessage interface. Messages may be identified using the MDataPersistentID subroutine or by any server ID (ServerID) associated with the message. Given either of these two identifiers, a result MDataMsgHandle may be obtained thereby allowing access to an existing messages data. The ServerID identifies the message on the application server 132-1-n if it is server resident. Regardless of protocol, the ServerID is typically a character string value. It is assumed that memcmp( ) can be used to compare a ServerID to another ServerID, and that for messages resident on mobile computing device 110, a zero (0) value is correct.

The IMessage interface also provides one or more object lifecycle API to create messages and delete them. The IMessage interface has accessor routines corresponding to the MIME header information for a message. The message body is treaded separately from the header information because the message body can be arbitrarily large. A stream like technique may be used to set and retrieve the message body. The stream technique can be called repeatedly to access the message body in a way not requiring the caller to have the entire body in memory at one time. Saving a message commits it to the database or persistent storage. Once committed, a persistent message ID may be retrieved through a MMsgGetPersistentID( ) subroutine. The identifier returned from this call may be stored beyond the use of the message, and later used to re-get a handle to the message for access. A MMsgRelease( ) subroutine cleans up all memory for the message and it is no longer accessible on the same handle.

In various embodiments, application client 504 may have other application client interfaces, such as an IFolder interface, an IAttach interface, and an ITransactionLog interface. The IFolder interface may provide access to folder information for an account. The IAttach interface may provide access to attachment information for a message in an account. The ITransactionLog interface may allow a SAM 506-1-m to query for changes needed to be synchronized to a corresponding application server 132-1-n.

Referring again to SAMR 502, SAMR 502 provides two primary sets of operations. First, SAMR 502 allows applications to discover registered SAM 506-1-m. Second, SAMR 502 provides a collection of common utility interfaces for all SAM 506-1-m to use. To support such operations, SAMR 502 may have one or more SAMR interfaces, such as an IRegister interface, an IQuery interface, an IDebug interface, and an IProgress interface. Upon being installed, or during a hard or soft reset, a SAM 506-1-m registers itself with SAMR 502. The SAM 506-1-m may register with SAMR 502 using the IRegister interface. At execution or runtime, application client 504 can inquire if a SAM 506-1-m is registered, and gain access to the registered SAM 506-1-m using the IQuery interface. SAMR 502 may also use the IDebug interface and IProgress interface for utility operations. For example, the IDebug interface may be used for debugging SAM or SAS modules, and the IProgress interface may be used for displaying progress of actions, when needed.

In one embodiment, SAMR 502 may be implemented as a shared library. It has a well-known name, creator, and type so it can be found easily using a set of SysLib API. As with the other components packaged as a shared library, all calls into SAMR 502 interfaces should include the library reference, defined as follows:
typedef Ulnt16 SAMgrRef.

In various embodiments, SAMR 502 may include an IRegister interface. The IRegister interface allows a SAM 506-1-m to register itself with application client 504 of mobile computing device 110, and also with any devices associated with mobile computing device 110, such as a desktop PC, for example. An example of an IRegister interface may be shown as follows:

Interface IRegister
{
Err ORegRegister( SAMgrRef ref, char *psamLibraryName, UInt32
samType, UInt32 samCreator, char *pdisplayName );
Err ORegUnregister( SAMgrRef ref, UInt32 samCreator );
}

The IRegister interface allows a SAM 506-1-m to register itself for use with application client 504. When registering, the SAM 506-1-m passes its creator, library name, type, and display name to SAMR 502. The first three values allow SAMR 502 to load a particular SAM 506-1-m when needed. The last value is used by application client 504 to display to users when configuring data access in application client 504. For example, if Lotus Notes and Exchange SAM 506-1-m are installed on the same device, application client 504 could allow the user to chose which SAM 506-1-m should be used for data access. Application client 504 could display a pick list containing the display names for each SAM 506-1-m to accomplish this. It is worthy to note that a creator, library name, and display name for each SAM 506-1-m are unique on a particular device.

A SAM 506-1-m may unregister itself from SAMR 502 using an ORegUnregister( ) subroutine. A SAM 506-1-m would call the unregister subroutine typically only prior to being deleted. It is worthy to note that unregistering a SAM 506-1-m only guarantees a SAM reference cannot be retrieved in the future by application client 504, while current references are not revoked. In the future SAMR 502 could reference count a SAM 506-1-m in order to let SAMR 502 know how many references are outstanding.

In various embodiments, SAMR 502 may include an IQuery interface. The IQuery interface allows application client 504 to determine whether a SAM 506-1-m is registered and how to get access to a registered SAM 506-1-m. An example of the IQuery interface may be shown as follows:

```
typedef _SAMHandle *SAMHandle;
typedef enum
{
    SAMgr_SAMLibName = 1,
} SAMgrQueryStrType;
typedef enum
{
    SAMgr_SAMType = 1,
    SAMgr_SAMCreator = 2
} SAMgrQueryU32Type;
Interface IQuery
{
        Err OQueryFirst( SAMgrRef ref, UInt32 applCreator, SAMHandle *psamH );
        Err OQueryNext( SAMgrRef ref, UInt32 applCreator,
                SAMHandle *psamH ); // in/out param, is prev on in
        Err OQueryByCreator( SAMgrRef ref, UInt32 samCreator, SAMHandle *psamH );
        Err OQueryByDisplayName( SAMgrRef ref, char *pdisplayNm, SAMHandle *psamH );
        Err OQueryGetString( SAMgrRef ref, SAMHandle samH, SAMgrQueryStrType what,
                    char **pvalue, UInt32 *plength );
        Err OQueryGetUInt32( SAMgrRef ref, SAMHandle samH, SAMgrQueryU32Type what,
                      UInt32 *pvalue );
        Err OQueryGetSAMRef( SAMgrRef ref, SAMHandle samH, SAMRef *pref );
}
```

The IQuery interface allows application client 504 to gain access to a SAM reference or its identifiers through SAMR 502. Application client 504 can use the iterator API to iterate over all the installed SAM 506-1-m that may support the application. The OQueryFirst( ) and OQueryNext( ) subroutines take the application creator as an argument so only those SAM 506-1-m that support the application can be returned. If an application wants to access all SAM 506-1-m regardless of support, then a zero (0) should be passed in for the creator value. Alternatively, a caller can access a SAM 506-1-m by knowing the creator of the SAM 506-1-m. These subroutines all return a variable SAMHandle which can then be used to call accessor routines to gain further information on the SAM 506-1-m or to get a SAM library reference, using the OQuerySAMGetRef( ) technique. An application may use this technique for loading a SAM 506-1-m for use, or alternative an application may use the SysLib API directly as well.

In various embodiments, SAMR 502 may include an IDebug interface. The IDebug interface specifies techniques to assist in debugging a SAM 506-1-m, such as exposing MMDebug logic, for example. An example of the IDebug interface may shown as follows:

```
Interface IDebug
{
      Err ODbgGet( SAMgrRef ref, UInt32 samCreator, Boolean *pon );
      Err ODbgSet( SAMgrRef ref, UInt32 samCreator, Boolean on );
      Err ODbgPrintF( SAMgrRef ref, UInt32 samCreator,
      char *pfmt, ... );
      Err ODbgStrCat( SAMgrRef ref, UInt32 samCreator, char *pmsg );
      Err ODbgWriteBytes(SAMgrRef ref, UInt32 samCreator,
      char *pbytes, UInt32 length );
      Err ODbgOutputEvent( SAMgrRef ref, UInt32 samCreator,
      char *plabel,
            EventPtr eventP, Boolean verbose, Boolean ignoreNil );
}
```

The IDebug interface is a utility interface allowing a debug log to be written to a word processor or text editor application on mobile computing device 110. The log contains whatever data the SAM 506-1-m decides to write to it, using the IDebug interface. This subroutine may be useful in troubleshooting a SAM 506-1-m for development, maintenance, upgrades and support. The IDebug interface allows a caller to turn on or off debug logging for a SAM 506-1-m based on the creator for the SAM 506-1-m. In this way logging turned on for one SAM 506-1-m will not affect the logging configuration for other installed SAM 506-1-m. IDebug supports a variety of logging techniques, some based on the print( ) style of API.

In various embodiments, SAMR 502 may include an IProgress interface. The IProgress interface allows a SAM 506-1-m to display a progress bar, thereby allowing a user to follow the progress of an action performed by the SAM 506-1-m. An example of an IProgress interface may be shown as follows:

```
typedef _Progress *OProgHandle;
typedef enum
{
      OProg_Label = 1,
      OProg_Title = 2
} OProgStrType;
Interface IProgress
{
      Err OProgDisplay( SAMgrRef ref, UInt32 totalItems,
      OProgHandle *pprogH );
      Err OProgSetString(SAMgrRef ref, OProgHandle progH,
      OProgStrType what, char *pvalue );
      Err OProgIncrement( SAMgrRef ref, OProgHandle progH,
      UInt32 newItemCnt );
      Err OProgHide(SAMgrRef ref, OProgHandle *pprogH );
}
```

The IProgress interface allows a SAM 506-1-m to display a progress bar for silent or non-silent actions. The IProgress interface provides techniques to display or hide a progress for an application, and increment a progress bar. A progress label and title may be set for the progress form. Single or multiple progress bars may be displayed.

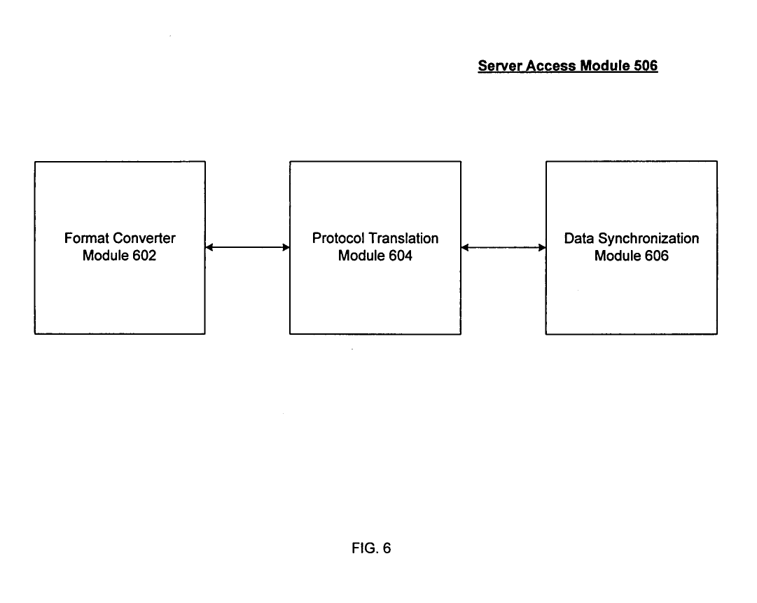

FIG. 6 illustrates one embodiment of a server access module. FIG. 6 illustrates a more detailed block diagram of a SAM 506-1-m as described with reference to FIG. 5. As shown in FIG. 6, a SAM 506-1-m may comprise a data format converter module 602, a protocol translation module 604, and a data synchronization module 606. The embodiments are not meant to be limited, however, to the example given in FIG. 6.

In various embodiments, a SAM 506-1-m may include a data format converter module 602. Data format converter module 602 may be arranged to convert information between an application client data format for application client 504 and an application server data format for a corresponding application server 132-1-n. In one embodiment, for example, application client 504 may modify information and store the modified information in the application client data format. Data format converter module 602 may retrieve the modified information in the application client data format, and convert the information to the application server data format. Data format converter module 602 may receive the modified information from the corresponding application server in the application server data format, and convert the information to the application client data format. The application client data format may include any uniform data model having predetermined data structures, data objects and/or data attributes recognized by application client 504. Similarly, the application server data format may include any uniform data model having predetermined data structures, data objects and/or data attributes recognized by an application server 132-1-n.

In various embodiments, a SAM 506-1-m may include a protocol translation module 604. Protocol translation module 506 may communicate information using an application server protocol for the corresponding application server. For mail servers, examples of application server protocols may comprise mail server protocols including POP, IMAP, EAS, WebDAV, SMTP, ESMTP, and so forth. Protocol translation module 506 may receive information from application client 504, and encode the information using the application server protocol. Protocol translation module 506 may receive information from the corresponding application server, and decode the information from the application server protocol for use by application client 504.

In various embodiments, a SAM 506-1-m may include a data synchronization module 606. Data synchronization module 606 may determine whether application client 504 has modified the information, and send the modifications to the corresponding application server. Data synchronization module 606 may determine whether the corresponding application server has modified the information, receive the modifications, and update application client 504 with the modifications.

In one embodiment, for example, a SAM 506-1-m can be triggered to perform synchronizations with an application server 132-1-n by application client 504 calling an IAction interface for the SAM 506-1-m. When an IAction operation is called, the SAM 506-1-m interacts with BSM 508 to carry out synchronization operations with the application server 132-1-n. The a SAM 506-1-m can choose to also use the networking capabilities of BSM 508 to form a foreground or background socket connection to the application server 132-1-n. In either case, the a SAM 506-1-m may be structured as a state machine, with each state called by BSM 508 to perform synchronization operations. The a SAM 506-1-m can also use utility routines implemented in SAMR 502 to aid in data conversion, as well as report results to the user.

During synchronization operations from mobile computing device 110 to an application server 132-1-n, the a SAM 506-1-m queries the IData interface for application client 504 to determine what changes, if any, need to be uploaded to the application server 132-1-n. The IData interface tracks changes made on mobile computing device 110 that the SAM 506-1-m has yet to synchronize, and uses an iterator to return these changes to the SAM 506-1-m when queried. The SAM 506-1-m then retrieves the data associated with the change, formats it for the application server 132-1-n in the expected protocol format, and sends it to the application server 132-1-n. The SAM 506-1-m can hand this formatted buffer to BSM 508 to send to the application server 132-1-n, or perform the networking itself.

During synchronization operations from an application server 132-1-n to mobile computing device 110, the IData interface provides facilities for the SAM 506-1-m to store objects on mobile computing device 110, and identify these objects with server identifiers (ID). Given a server ID, the SAM 506-1-m can query for the object it represents, and given an object handle the SAM 506-1-m can get its server ID attribute. Utility routines may also exist in SAMR 502 for converting between different date formats, and for dealing with time zone support.

If the application desired the SAM 506-1-m to execute synchronization operations in the foreground, the SAM 506-1-m may use various SAMR 502 progress bar routines to display a progress user interface. If the application desired the SAM 506-1-m to execute synchronization operations in the background, then the SAM 506-1-m can use the SAMR 502 notification routines to notify the user of the number of items synchronized, or of any errors that may have occurred. It is worthy to note that BSM 508 in conjunction with the IData interface insures that objects can successfully be synchronized in the background while the application using those objects is running in the foreground.

Operations for the above embodiments may be further described with reference to the following figures and accompanying examples. Some of the figures may include a logic flow. Although such figures presented herein may include a particular logic flow, it can be appreciated that the logic flow merely provides an example of how the general functionality as described herein can be implemented. Further, the given logic flow does not necessarily have to be executed in the order presented unless otherwise indicated. In addition, the given logic flow may be implemented by a hardware element, a software element executed by a processor, or any combination thereof. The embodiments are not limited in this context.

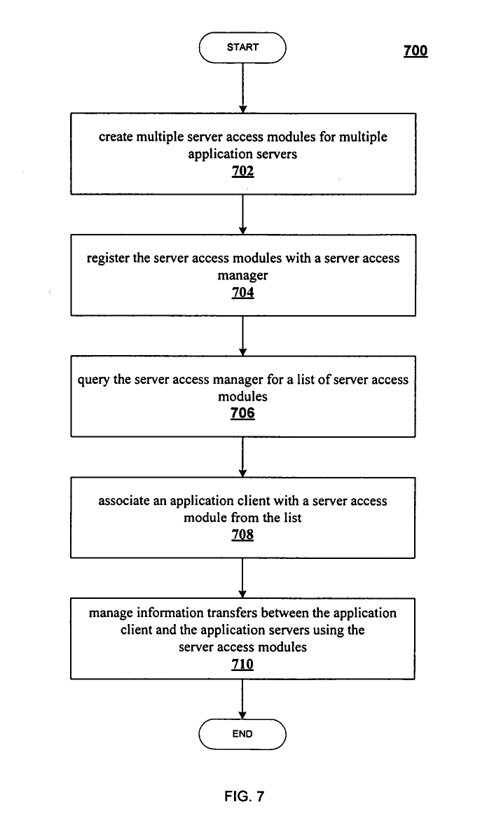

FIG. 7 illustrates one embodiment of a logic flow. FIG. 7 illustrates a logic flow 700. Logic flow 700 may be representative of the operations executed by one or more embodiments described herein, such as mobile computing device 110, application client 504, SAM 506-1-m, and/or application servers 132-1-n. As shown in logic flow 700, multiple server access modules may be created for multiple application servers at block 702. The server access modules may be registered with a server access manager at block 704. The server access manager may be queried for a list of server access modules at block 706. An application client may be associated with a server access module from the list at block 708. Information transfers between the application client and the application servers may be managed using the server access modules at block 710. The embodiments are not limited in this context.

In various embodiments, information transfers may be managed using a number of different techniques. In one embodiment, for example, certain information may be synchronized between the application client and a corresponding application server. Synchronizing information between the application client and the application servers may be performed concurrently. In one embodiment, for example, certain information may be translated between the application client and the corresponding application server using an application server protocol for the corresponding application server. In one embodiment, for example, certain information may be converted between an application client data format for the application client and an application server data format for the corresponding application server. Other techniques may be possible, and the embodiments are not limited in this context.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

It is also worthy to note that any reference to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

Some embodiments may be implemented using an architecture that may vary in accordance with any number of factors, such as desired computational rate, power levels, heat tolerances, processing cycle budget, input data rates, output data rates, memory resources, data bus speeds and other performance constraints. For example, an embodiment may be implemented using software executed by a general-purpose or special-purpose processor. In another example, an embodiment may be implemented as dedicated hardware, such as a circuit, an application specific integrated circuit (ASIC), Programmable Logic Device (PLD) or digital signal processor (DSP), and so forth. In yet another example, an embodiment may be implemented by any combination of programmed general-purpose computer components and custom hardware components. The embodiments are not limited in this context.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

Some embodiments may be implemented, for example, using any computer-readable media, machine-readable media, or article capable of storing software. The media or article may include any suitable type of memory unit, memory device, memory article, memory medium, storage device, storage article, storage medium and/or storage unit, such as any of the examples described with reference to memory 406. The media or article may comprise memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), subscriber identify module, tape, cassette, or the like. The instructions may include any suitable type of code, such as source code, object code, compiled code, interpreted code, executable code, static code, dynamic code, and the like. The instructions may be implemented using any suitable high-level, low-level, object-oriented, visual, compiled and/or interpreted programming language, such as C, C++, Java, BASIC, Perl, Matlab, Pascal, Visual BASIC, JAVA, ActiveX, assembly language, machine code, and so forth. The embodiments are not limited in this context.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

While certain features of the embodiments have been illustrated as described herein, many modifications, substitutions, changes and equivalents will now occur to those skilled in the art. It is therefore to be understood that the appended claims are intended to cover all such modifications and changes as fall within the true spirit of the embodiments.

1. A mobile computing device, comprising:
an application client; and
multiple server access modules each corresponding to a different type of application server, each server access module comprising:
a data synchronization module to synchronize information between said application client and a corresponding application server;
a protocol translation module to communicate information using an application server protocol for said corresponding application server; and
a data format converter to convert information between an application client data format for said application client and an application server data format for said corresponding application server.

2. The mobile computing device of claim 1, comprising a background services module, said data synchronization modules to synchronize said information with said application clients concurrently using said background services module.

3. The mobile computing device of claim 1, said protocol translation module to receive information from said application client, and encode said information using said application server protocol.

4. The mobile computing device of claim 1, said protocol translation module to receive information from said corresponding application server, and decode said information from said application server protocol.

5. The mobile computing device of claim 1, said data synchronization module to determine whether said application client has modified said information, and to send said modifications to said corresponding application server.

6. The mobile computing device of claim 1, said data synchronization module to determine whether said corresponding application server has modified said information, to receive said modifications, and update said application client with said modifications.

7. The mobile computing device of claim 1, said application client to modify said information and store said information in said application client data format, said data format converter to retrieve said information in said application client data format, and to convert said information to said application server data format.

8. The mobile computing device of claim 1, said data format converter to receive said information from said corresponding application server in said application server data format, and convert said information to said application client data format.

9. The mobile computing device of claim 1, comprising a server access module manager, with each server access module to register with said server access module manager, and said application client to discover said server access modules by querying said server access module manager.

10. A system, comprising:
an antenna;
a radio sub-system to connect to said antenna, said radio sub-system to provide voice communications; and
a processing sub-system to connect to said radio sub-system, said processing sub-system having a processor and memory, said memory to store software components for execution by said processor, said software components including an application client and multiple server access modules each corresponding to a different type of application server, each server access module comprising:
a data synchronization module to synchronize information between said application client and a corresponding application server;
a protocol translation module to communicate information using an application server protocol for said corresponding application server; and
a data format converter to convert information between an application client data format for said application client and an application server data format for said corresponding application server.

11. The system of claim 11, comprising a background services module, said data synchronization modules to synchronize said information with said application clients concurrently using said background services module.

12. The system of claim 11, said protocol translation module to receive information from said application client, and encode said information using said application server protocol.

13. The system of claim 11, said protocol translation module to receive information from said corresponding application server, and decode said information from said application server protocol.

14. The system of claim 11, said data synchronization module to determine whether said application client has modified said information, and to send said modifications to said corresponding application server.

15. The system of claim 11, said data synchronization module to determine whether said corresponding application server has modified said information, to receive said modifications, and update said application client with said modifications.

16. The system of claim 11, said application client to modify said information and store said information in said application client data format, said data format converter to retrieve said information in said application client data format, and to convert said information to said application server data format.

17. The system of claim 11, said data format converter to receive said information from said corresponding application server in said application server data format, and convert said information to said application client data format.

18. The system of claim 11, comprising a server access module manager, with each server access module to register with said server access module manager, and said application client to discover said server access modules by querying said server access module manager.

19. A method, comprising:
creating multiple server access modules for multiple application servers;
registering said server access modules with a server access manager;
querying said server access manager for a list of server access modules;
associating an application client with a server access module from said list; and
managing information transfers between said application client and said application servers using said server access modules.

20. The method of claim 19, comprising synchronizing information between said application client and a corresponding application server.

21. The method of claim 19, comprising synchronizing information between said application client and said application servers concurrently.

22. The method of claim 19, comprising communicating information between said application client and said corresponding application server using an application server protocol for a corresponding application server.

23. The method of claim 19, comprising converting information between an application client data format for said application client and an application server data format for a corresponding application server.

24. An article comprising a machine-readable storage medium containing instructions that if executed enable a system to create multiple server access modules for multiple application servers, register said server access modules with a server access manager, query said server access manager for a list of server access modules, associate an application client with a server access module from said list, and manage information transfers between said application client and said application servers using said server access modules.

25. The article of claim 24, further comprising instructions that if executed enable the system to synchronize information between said application client and a corresponding application server.

26. The article of claim 24, further comprising instructions that if executed enable the system to synchronize information between said application client and said application servers concurrently.

27. The article of claim 24, further comprising instructions that if executed enable the system to communicate information between said application client and said corresponding application server using an application server protocol for a corresponding application server.

28. The article of claim 24, further comprising instructions that if executed enable the system to convert information between an application client data format for said application client and an application server data format for a corresponding application server.
